(19) United States
(12) Patent Application Publication
(10) Pub. No.: US 2018/0093905 A1
(43) Pub. Date: Apr. 5, 2018

(54) Vacuum Membrane Desalination System

(71) Applicant: Xergy Inc., Georgetown, DE (US)

(72) Inventors: Bamdad Bahar, Georgetown, DE (US); Luyu Jin, Newark, DE (US); Mark Goldben, Seaford, DE (US)

(21) Appl. No.: 15/698,886

(22) Filed: Sep. 8, 2017

Related U.S. Application Data
(60) Provisional application No. 62/385,178, filed on Sep. 8, 2016.

(51) Int. Cl. C02F 1/46; C02F 1/10; C02F 1/14; C02F 1/44; C02F 1/78

(52) U.S. Cl. CPC C02F 1/4604; C02F 1/10; C02F 2103/08; C02F 1/447; C02F 1/78; C02F 1/14

(57) ABSTRACT

A desalination system employs vacuum to evaporate heated water through a separator material. The evaporated water is then passed through a heat exchanger wherein the heat is exchanged with an inflow of water to the system to heat the incoming water and greatly increase the overall system efficiency. The incoming water heated in the heat exchanger may then be passed to a heater to further heat the water before being provided to an evaporator. A vacuum is drawn across a separator material in the evaporator to produce evaporated water vapor that is purified. This water vapor is then provided to the heat exchanger, wherein the water vapor is condensed and the incoming water is heated. An ozone disinfecting system may produce ozone that is mixed with the condensed water to produce a purified and disinfected water that is suitable for consumption.

### CROSS REFERENCE TO RELATED APPLICATIONS

This application claims the benefit of provisional patent application No. 62/385,178, filed on Sep. 8, 2016, entitled Electrochemical Desalination System; the entirety of which is hereby incorporated by reference herein.

### BACKGROUND OF THE INVENTION

This invention was made with government support under Government Contract Grant No. DE-SC0015923 awarded by Department of Energy. The government has certain rights in the invention.

### FIELD OF THE INVENTION

The present invention relates to a desalination system.

### BACKGROUND

Prior art patents such as Multi-phase Selective Mass Transfer Through a Membrane, U.S. Pat. No. 8,500,960B, to Ehrenberg et al., has disclosed selective mass transfer systems that be utilized for material separation, such for example removing water from sea water, or salt water streams.

However, the embodiments provided in the patent and literature to date, have only disclosed the actual membrane separation unit, but not identified important elements that are required in practical applications. For example, sea water normally has components such as particulates that need to be removed prior to the membrane based multi-phase separation system, since particulates can damage the membranes.

Also, clearly the system requires energy to perform the selective process. Yet, methods of integrating independent power generation into the overall system have not been disclosed or analyzed. Many potential applications of this system involve remote settings where solar power would be necessary. However, while pumps and other components of the system require electrical energy, the multi-phase selective process actually needs thermal energy to enable evaporation through the membrane. Solar powered systems would be susceptible to insufficient power dues to cloudy days and operation at night.

Another important consideration, is the overall system efficiency. There are many methods for sea water desalination including Reverse Osmosis systems, RO systems.

One final consideration for a stand alone unit, providing potable water in a remote setting is the disinfection of the water once produced and stored in an adjacent vessel. This patent discloses the use of a small (compact) ozone generator for water purification.

### SUMMARY OF THE INVENTION

The invention is directed a desalination system that employs vacuum to evaporate heated water through a separator material. The evaporated water is then passed through a heat exchanger wherein the heat is exchanged with an inflow of water to the system to heat the incoming water and greatly increase the overall system efficiency. Utilizing this latent heat of evaporation to heat the incoming water increases the overall efficiency of the system. The incoming water may be salt water, seawater or brackish water, for example. The incoming water heated in the heat exchanger may then be passed to a heater to further heat the water before being provided to an evaporator. A vacuum is drawn across a separator material in the evaporator to produce evaporated water vapor that is purified. This water vapor is then provided to the heat exchanger, wherein the water vapor is condensed and the incoming water is heated. An ozone disinfecting system may produce ozone that is mixed with the condensed water to produce a purified and disinfected water that is suitable for consumption. In addition, evaporating salt or brackish water can be done at lower temperatures that non-salt or brackish water. This increased rate of evaporation of the at least brackish water increase the system efficiency.

The heater may be any suitable heater but in an exemplary embodiment is a solar heater. A solar heater may heat the water by passing it through light absorbing conduits.

The separator material may be any material that allows water vapor to pass therethrough but prevents liquid water from passing and may be a hydrophobic membrane, or a thin film of material including, but not limited to, an ionomer, a urethane or other polymer having a high moisture vapor transmission rate, MVTR. Other separator materials included, but are not limited to, Nafion®, PSFA, sulfonated PEEK (poly ether ether Ketone), PES (poly ether sulfone), Polymer-SEBS, poly(arylene), and polyolefin, sulfonated urethanes.

A separator membrane may be non-air permeable, having no bulk flow of air therethrough, and may be film. A non-air permeable separator, as used herein will have a Gurley value of about 100 seconds or more, and preferably 200 second or more, and in some cases about 500 seconds or more, as measured by an Automatic Gurley Densometer, 4340, from Gurley Instruments Inc.

An exemplary separator material may be very thin to increase the MVTR, or rate of transfer of the water vapor and may have a thickness of about 50 micron or less, about 25 microns or less, about 15 microns or less and any range between and including the thickness values provided. A separator material may comprise a support material that mechanically reinforces the separator material such as a net, mesh, woven material or membrane. An exemplary support material is an expanded polymer membrane and water vapor polymer, such as an ionomer or urethane may be imbibed into or otherwise attached to the expanded membrane. An exemplary expanded polymer membrane is expanded polytetrafluoroethylene, available from W.L. Gore and Associates, Inc. An expanded polymer membrane may be preferred as it is very thin and strong.

An exemplary desalination system may comprise a renewable power source such as a solar panel, or photovoltaic array, or wind power generator and the like. An exemplary desalination system may be remote and be self-powered, thereby not requiring power from grid power and wherein all power required is produced by renewable power sources. A renewable power source may provide electrical power to the components of the system directly and/or may store power in a battery or battery pack for later use. For example, during the day, a solar panel may provide power directly to the desalination system and may also provide power to a battery pack. During the night, the desalination system may be powered by the battery pack.

This application incorporates by reference, in their entirety, U.S. provisional patent application No. 62/353,545, filed on Jun. 22, 2016, provisional patent application No. 62/258,945 filed on Nov. 23, 2015 and provisional patent application No. 62/373,329 filed on Aug. 10, 2016.

This application incorporates by reference, in their entirety, the following: U.S. provisional patent application No. 62/171,331, filed on Jun. 5, 2015 and entitled Electrochemical Compressor Utilizing a Preheater; U.S. patent application Ser. No. 14/859,267, filed on Sep. 19, 2015, entitled Electrochemical Compressor Based Heating Element and Hybrid Hot Water Heater Employing Same; U.S. patent application Ser. No. 13/899,909 filed on May 22, 2013, entitled Electrochemical Compressor Based Heating Element And Hybrid Hot Water Heater Employing Same; U.S. provisional patent application No. 61/688,785 filed on May 22, 2012 and entitled Electrochemical Compressor Based Heat Pump For a Hybrid Hot Water Heater; U.S. patent application Ser. No. 14/303,335, filed on Jun. 12, 2014, entitled Electrochemical Compressor and Refrigeration System; U.S. patent application Ser. No. 12/626,416, filed on Nov. 25, 2009, entitled Electrochemical Compressor and Refrigeration System now U.S. Pat. No. 8,769,972; and U.S. provisional patent application No. 61/200,714, filed on Dec. 2, 2008 and entitled Electrochemical Compressor and Heat Pump System; the entirety of each related application is hereby incorporated by reference.

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a diagram of an exemplary filtration system.

FIG. 2 shows a diagram of an exemplary heat exchanger.

FIG. 3 shows a diagram of an exemplary ozone disinfecting device.

FIG. 4 shows a diagram of an exemplary heat exchanger.

FIG. 5 shows a diagram of an exemplary solar powered system.

FIG. 6 shows a diagram of an exemplary desalination system as described herein.

FIG. 7 shows a diagram of an exemplary desalination system as described herein.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

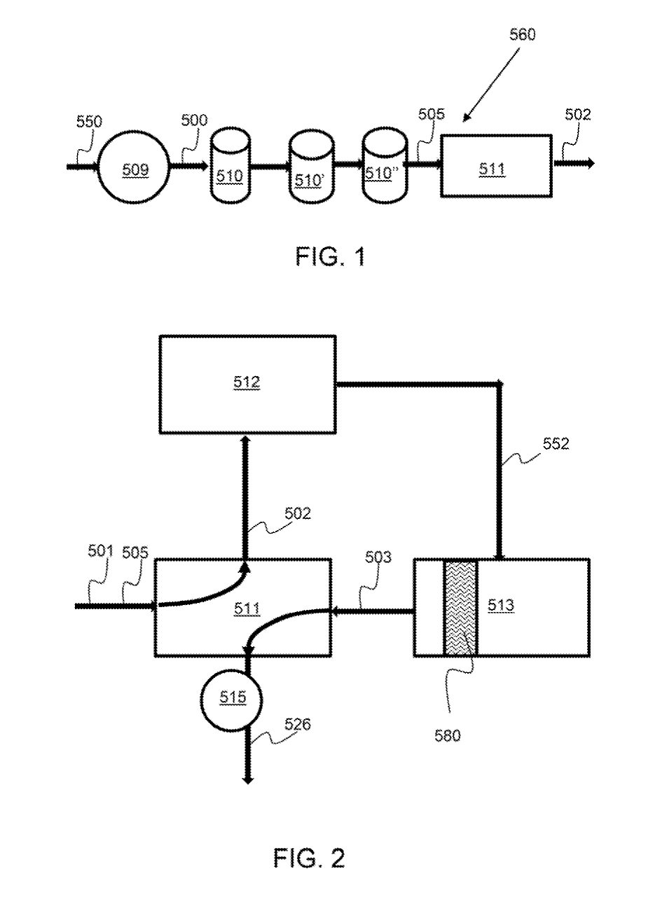

As shown in FIG. 1, a water filtration system 560 purifies untreated water 550. Filtered water 505 is produced by pumping untreated water 550 through one or more filters 510. The pump 509 provides an inlet flow of water 500 to a multistage filtration system comprising a plurality of filters 510-510″. A multistage filtration system is often utilized to produce filtered water 505 and in some cases purified water 505 that may be suitable for consumption. For example, raw sea water may be pumped by pump 509 through a multistage filtration unit. For example, the most common combination is a 5-micron polypropylene sediment melt blown filter, CTO carbon block cartridge, and a GAC coconut Shell Carbon Filter. Sediment filter removes sand and big particles, Carbon& GAC filter remove odors, taste& chemicals, including chlorine, herbicides, and pesticides. Since these filters provide purifier water to the rest of system, it reduced chance of fouling, which could increase the lifetime of the whole system. The filtered water may be purified water that is suitable for consumption and may be passed through a heat exchanger 511 to produce heated water 502.

As shown in FIG. 2, the filtered water 505 which may be purified water 501 is pumped through the heat exchanger 511. The heat exchanger heats the purified water from the latent heat of evaporation of the hot water vapor. The heat exchanger is an evaporator for the water vapor 503 that has been drawn through the separator material 580 in the evaporator 513. A separator material may comprise a water vapor transfer polymer, such as an ionomer or urethane, and a support material 581, such as an expanded fluoropolymer. The heated water 502 is then passed to a heater 512, which may be a solar heater. The heated water 552, heated to a higher temperature than heated water 502 is then passed to an evaporator 512. The evaporator produces hot water vapor 503 that is condensed in the heat exchanger 511. The heated water 552 may be brackish salt water that has a lower temperature of evaporation. Vacuum is formed across the separator material by vacuum pump 515 to evaporate the heated water 552 to hot water vapor 503. The hot water vapor is condensed in the heat exchanger 511 to form condensed purified water 526. Heat from the hot water vapor 503 is exchanged in the heat exchanger with the filtered water 505 to produce heated water 502. By using this system, the filtered water is condensed and a large amount of heat is recovered.

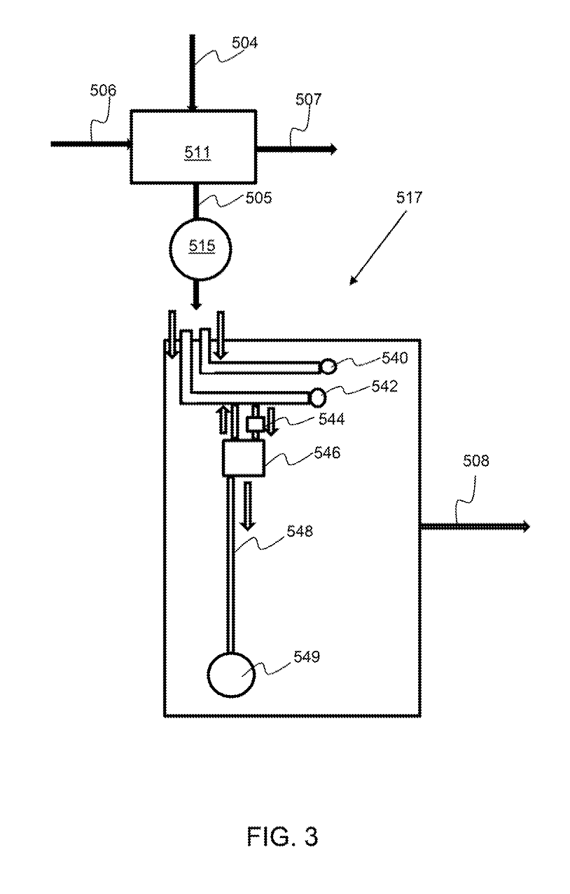

As shown in FIG. 3, fresh water 505 is provided to an ozone disinfection device 517. The ozone disinfection device produces ozone to treat the filtered water 505 pumped by the vacuum pump 515 to produce disinfected fresh water 508. The ozone disinfection device comprises a hot water feed 540, a cold water feed 542, a flow sensor 544, an ozone producing device 546, such as an electrolyzer, a cathode drain 548 that leads to a main drain 549. The ozone producing device may be an electrolyzer of an electrochemical ozone generator 570 comprising an electrochemical cell that produces ozone with an applied voltage potential across a membrane electrode assembly as described in U.S. patent application Ser. No. 15/698,842, entitled Ozone Generator System, filed on Sep. 8, 2017 and hereby incorporated by reference in its entirety.

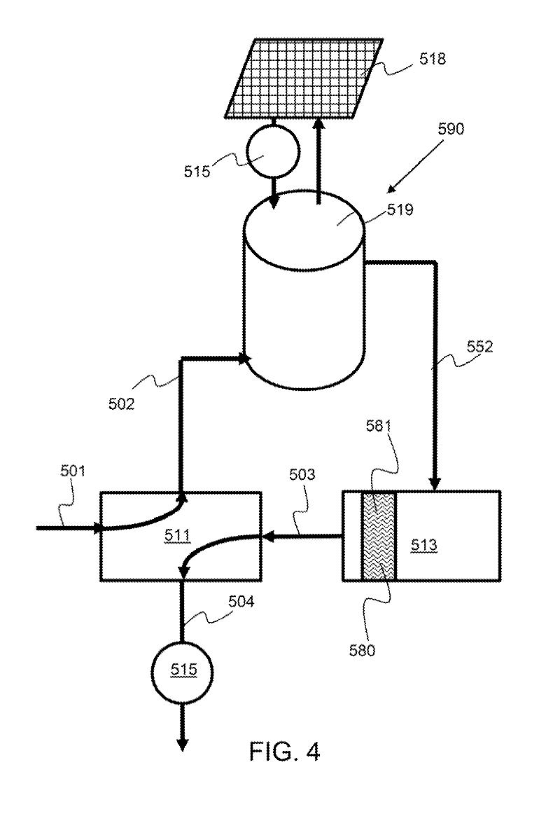

As shown in FIG. 4, a solar heating system 590 would be the second stage heating. There is a closed glycol-water loop between solar panels 518, or photovoltaic cells, and the solar water tank 519. The solar water tank will heat the water within the solar water tank. Water is pumped by pump 515 from the solar heater to the solar water tank. These solar water tank should be noncorrosive, which is usually made by plastic and titanium. And this system could bring the temperature of seawater to a higher point with free clean energy. Heated water 502 from the heat exchanger may enter the solar hot water heater and be heated to an increased or second temperature by the solar panels 518. The heated water 552 would then be provided to the evaporator 513 from the solar water tank 519. Finally, heated water 503 is provide from the evaporator to the heat exchanger 511.

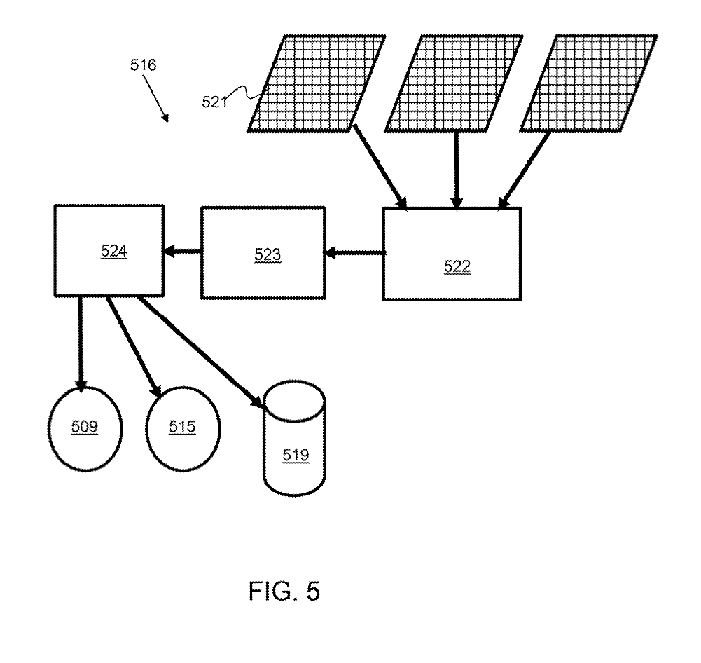

Referring to FIG. 5, solar power system 516 could be used to run the whole desalination system with an evaporator. Photovoltaic cells or panels are used to create electricity from solar energy or sunlight. Multiple solar panels 521 may be connected in series or in parallel. The solar panels are controlled by the solar charge controller 522. A power inverter 523 may convert the DC electricity produced by the solar panels 521 to AC electricity. A voltage regulator may also be provided to regulate the voltage to a suitable voltage, such as a constant 12V or 24V, for example. Finally, this energy will be stored in a battery bank 524. The battery bank may then provide electrical power to components of the system, such as to the pump 509, vacuum pump 515, and/or water heater 519. The components of the desalination system could receive electrically power from the solar panels 521 directly.

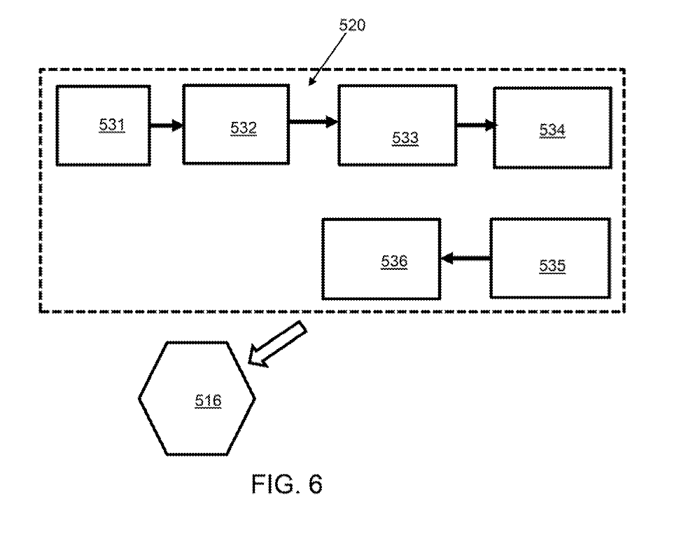

Referring to FIG. 6, this backup power system 520 may be used to ensure that power is available for a desalination system. This Backup Power System 520 comprises an electrolyzer 531, electrochemical compressor 532, metal hydride storage 534, fuel cell 535 and charge controller 536. As a result, the backup power system 520 will provide electricity to the solar power system 516. The entire desalination system may be powered by this backup power system. A plurality of electrochemical compressors, 532 and 533 may be provided with this system.

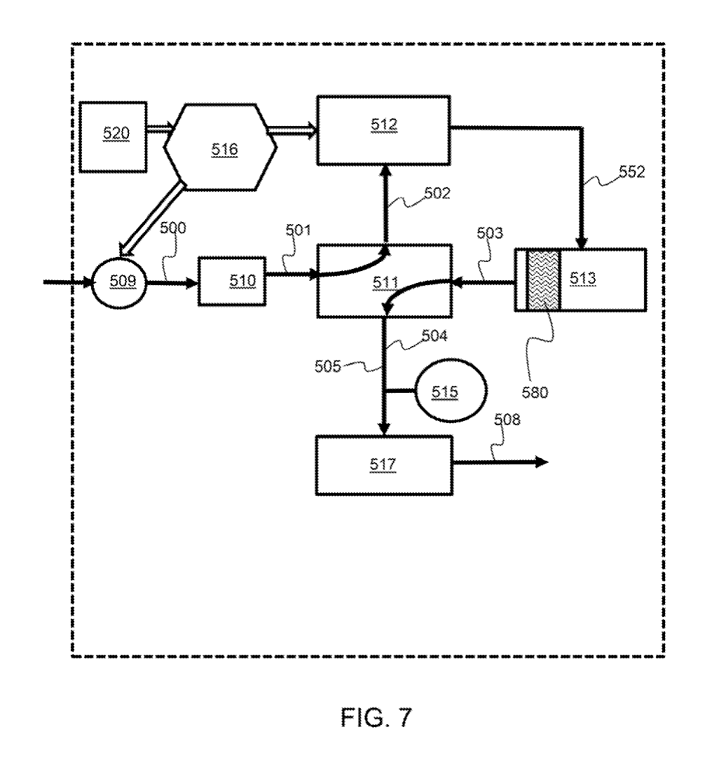

Referring to FIG. 7, all the improvements of the desalination system could be integrated to one system at the same time. FIG. 7 shows the desalination system that processes raw seawater from an inlet flow of water 500, to produce a disinfected purified water 508.

It will be apparent to those skilled in the art that various modifications, combinations and variations can be made in the present invention without departing from the spirit or scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A desalination system comprising:
a) a heater;
b) an evaporator;
c) a heat exchanger comprising:
i) an inlet for an inlet flow of water;
ii) an inlet for water vapor;
d) an evaporator;
e) a separator membrane that is liquid impermeable;
f) a vacuum pump that produces a vacuum across the separator membrane;
wherein the inlet flow of water is heated in the heat exchanger by the water vapor to form a first heated water and wherein the water vapor is condensed in the heat exchanger to form purified condensed water.
wherein the heater receives said first heated water from the heat exchanger and heats the first heated water to produce a second heated water;
wherein the evaporator receives the second heated water;
wherein the separator separates the second heated water from the water vapor.

2. The desalination system of claim 1, wherein the inlet flow of water is salt water.

3. The desalination system of claim 1, further comprising a filtration system that filters contaminates from the inlet flow of water to produce filtered water that is supplied to the heat exchanger.

4. The desalination system of claim 1, wherein the heater is a solar heater.

5. The desalination system of claim 1, further comprising a water tank configured between the heater and the evaporator to store the second heated water.

6. The desalination system of claim 1, further comprising an ozone disinfection device produces ozone that is mixed with the purified condensed water to produce a disinfected purified water.

7. The desalination system of claim 1, further comprising a renewable power source that produce electrical power and wherein said electrical power is used to power the vacuum pump.

8. The desalination system of claim 7, wherein the renewable power source comprises a solar panel.

9. The desalination system of claim 7, further comprising a battery for storing the electrical power produced by the renewable power source.

10. The desalination system of claim 1, wherein the separator material is non-air permeable.

11. The desalination system of claim 10, wherein the separator material comprises an ionomer.

12. A desalination system comprising:
a) a solar heater;
b) an evaporator;
c) a heat exchanger comprising:
i) an inlet for an inlet flow of water;
ii) an inlet for water vapor;
d) an evaporator;
e) a separator membrane that is liquid impermeable;
f) a vacuum pump that produces a vacuum across the separator membrane;
wherein the inlet flow of water is heated in the heat exchanger by the water vapor to form a first heated water and wherein the water vapor is condensed in the heat exchanger to form purified condensed water.
wherein the heater receives said first heated water from the heat exchanger and heats the first heated water to produce a second heated water;
wherein the evaporator receives the second heated water;
wherein the separator separates the second heated water from the water vapor
g) a renewable power source that produce electrical power and wherein said electrical power is used to power the vacuum pump.

13. The desalination system of claim 12, further comprising a battery for storing the electrical power produced by the renewable power source.

14. A method of desalinating water providing the steps of:
a) Providing a desalination system
i) a heater;
ii) an evaporator;
iii) a heat exchanger comprising:
an inlet for an inlet flow of water;
an inlet for water vapor;
iv) an evaporator;
v) a separator membrane that is liquid impermeable;
vi) a vacuum pump that produces a vacuum across the separator membrane;
b) heating the inlet flow of water in the heat exchanger by the water vapor to form a first heated water;
c) heating the first heated water in the heater to form a second heated water;
d) evaporating the second heated water in the evaporator to form water vapor;
e) condensing the water vapor in the heat exchanger to form purified condensed water;

15. The method of desalinating water of claim 14, further comprising the step of providing a filtration system that filters contaminates from the inlet flow of water to produce filtered water that is supplied to the heat exchanger.

16. The method of desalinating water of claim 14, wherein the heater is a solar heater.

17. The method of desalinating water of claim 14, further comprising the step of providing an ozone disinfection device that produces ozone that is mixed with the purified condensed water to produce a disinfected purified water.

18. The method of desalinating water of claim 14, further comprising the step of providing a renewable power source that produces electrical power and wherein said electrical power is used to power the vacuum pump.

19. The method of desalinating water of claim 17, wherein the renewable power source comprises a solar panel.

20. The method of desalinating water of claim 17, further comprising the step of providing a battery for storing the electrical power produced by the renewable power source.
